(19) United States
(12) Patent Application Publication
(10) Pub. No.: US 2022/0058906 A1
(43) Pub. Date: Feb. 24, 2022

(54) CONTACTLESS OBJECT DISPENSING FROM OBJECT-DISPENSING MACHINES

(71) Applicant: BANK OF AMERICA CORPORATION, Charlotte, NC (US)

(72) Inventors: Srinivas Dundigalla, Charlotte, NC (US); Mohan Rao Balan, Pattabiram (IN); Pavan Kumar Chayanam, Alamo, CA (US); Varsha Devadas, Seattle, WA (US); Tony England, Teca Cay, SC (US); Hari Gopalkrishnan, Plainsboro, NJ (US); Brandon Kozlowski, Charlotte, NC (US); Kurt A. Loth, Concord, CA (US); Navdeep Mahajan, Charlotte, NC (US); Carl Parziale, Charlotte, NC (US); Rupal V. Shah, Loomis, CA (US); Manoj Shankar, Bothell, WA (US); David Smiddy, Chadds Ford, PA (US); Cory Scott Turco, Charlotte, NC (US); Robert L. Wright, JR., Ponte Vedra Beach, FL (US); Xianhong Zhang, Issaquah, WA (US); Pavan Singaraju, Charlotte, NC (US)

(73) Assignee: BANK OF AMERICA CORPORATION, Charlotte, NC (US)

(21) Appl. No.: 16/999,973

(22) Filed: Aug. 21, 2020

(51) Int. Cl. G07D 11/60; H04W 4/80; H04L 29/08; H04W 12/06; G06Q 30/00; G06Q 20/10; G06Q 20/20; G06Q 20/32; G06Q 20/40; G06Q 40/02; G06Q 20/22; G06K 7/10; G07D 11/22

(52) U.S. Cl. CPC G07D 11/60; G06Q 20/352; H04L 67/26; H04W 12/0608; G06Q 30/0185; G06Q 20/1085; G06Q 20/206; G06Q 20/202; G06Q 20/3223; G06Q 20/3224; G06Q 20/3278; G06Q 20/407; G06Q 40/02; G06Q 20/326; G06Q 20/227; G06Q 20/4037; G06Q 20/203; G06K 7/10366; G07D 11/22; H04W 4/80

(57) ABSTRACT

Contactless dispensing of objects from object-dispensing machines. A digital token is wirelessly communicated to the machine via short-range wireless communication, such as Near Field Communication (NFC) or the like. In response, a push notification is communicated to the user's wireless device, which includes an activatable link for launching a mobile application. In response to launching the mobile application and authenticating the user, the mobile application provides object-dispensing machine-like user interfaces that are configured to allow the user to input object requesting parameters and submit a request for objects to be dispensed from the object-dispensing machine. The request is communicated to the object-dispensing machines (or corresponding backend processing systems) and, once the request is verified, the object-dispensing machine dispenses the requested objects.

### FIELD OF THE INVENTION

The present invention relates to dispensing objects from machines, and more particularly, to systems, methods, computer program products and the like for contactless dispensing of objects from object-dispensing machines.

### BACKGROUND

The problem with most machines that dispense objects to individuals (e.g., vending machines, Automated Teller Machines (ATM) or the like) is that the machines require a user to physically interface with various input mechanisms (buttons, touchscreens or the like) on the machine in order to complete the dispensing process. Since these types of machines incur continuous use by different individuals, the likelihood of individuals acquiring germs from physically touching the input mechanisms is high. In the case of touchscreens, this problem is seemingly unavoidable, since a touchscreen sensor requires that inputs be provided by a finger or a specialized stylus.

Heretofore, attempts to address the problem related to users having to physically contact object-dispensing machines have been ineffective or inefficient. In this regard, some of the proposed solutions still require the user to at least make minimal contact with the object-dispensing machine. In other instances, the proposed solutions are so cumbersome to the user that the user would rather forego using the solution and instead run the risks associated with contacting the object-dispensing machine.

Therefore, a need exists to develop systems, methods, computer program products and the like that provide contactless dispensing of objects from object-dispensing machines. The desired systems, methods, computer program products and the like should allow a user to obtain an object dispensed from such a machine without having to physically contact the machine. In addition, the desired systems, methods and computer program products should provide for an efficient and easily implemented means of obtaining the dispensed object without physically contacting the machine. In this regard, the desired, systems, methods, computer program products and the like should allow the user to obtain the object within the same timeframe that a user would obtain the object if they were to physically contact the machine. Further, the process by which the user contactlessly obtains the dispensed object should be highly intuitive so that the user is not required to recall what needs to take place in order for the contactless process to ensue.

### SUMMARY OF THE INVENTION

The following presents a simplified summary of one or more embodiments in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing for a seamless system, methods and the like for contactless dispensing of objects from object-dispensing machines, such as vending machines, ATMs or the like.

Specifically, the process avoids any contact with the object-dispensing machine by initially having a user transfer a user-identifying digital token to the machine via short-range wirelessly communication. For example, a card device or mobile communication device equipped with a Near Field Communication (NFC) chip is “tapped” (i.e., come within a near-field range) at a corresponding NFC reader within or proximate to the object-dispensing machine. The information stored within the token allows for the object-dispensing machine (or network-accessible backend systems connected to the object-dispensing machine) to determine that the user is registered for contactless object dispensing and a mobile communication device identifier that the user has associated with the contactless object dispensing process.

In response, the backend system communicates a push notification to the mobile communication device which notifies the user of the contactless process and asks the user to activate a link in the notification to launch a mobile application on the mobile device. Once the mobile application launches, the user is initially required to provide authentication credentials (e.g., pin number, biometric data or the like). Upon verification of the authentication credentials, the user is provided an object-dispensing machine-like experience through the mobile application. For example, in the ATM scenario in which the user desires to withdraw currency notes, the user is presented with ATM-like user interfaces that allow the user to select an account from which the withdrawal will occur and the withdrawal amount. Once the user submits the request via the mobile application, the request is communicated to the backend system, which performs one or more verifications procedures (e.g., ensures that the selected account contains sufficient funding) and subsequently communicates a command to the object-dispensing machine instructing the machine to dispense the object(s).

The resulting contactless object dispensing process is highly intuitive and seamless, allowing users to obtain objects from the object-dispensing machine within the same timeframe the user would encounter if the user chose to physically contact the machine.

A system for contactless dispensing of objects from an object-dispensing apparatus defines first embodiments of the invention. The system includes an object-dispensing apparatus that includes a first memory, at least one first processing device in communication with the memory, a short-range wireless communication reader in communication with the processing device(s) and first instructions stored in the first memory and executable by the first processing device(s). The first instructions are configured to activate the short-range wireless communication reader to receive and read a token associated with a user, and determine, based on the token, a mobile communication device identifier associated with a mobile communication device utilized by the user. Further, the object-dispensing apparatus is configured to communicate a push notification to the mobile communication device based on the mobile communication device identifier. The push notification is configured to notify the user of the contactless process and provide an activatable link configured to launch a mobile application on the mobile communication device.

The system additionally includes the mobile communication device that includes a second memory, a second processing device in communication with the second memory, a display in communication with the second processing device and second instructions stored in the second memory and executable by the second processing device. The second instructions are configured to receive the push notification and present the push notification on the display.

In addition the system includes the mobile application that is stored in the second memory, executable by the second processing device and configured to launch in response to the user selecting the activatable link in the push notification, and, in response to launch, request and receive user authentication credentials. Further, the mobile application is configured to, in response to verifying the user authentication credentials, present, on the display, one or more user interfaces that are configured to allow the user to submit a request for the object-dispensing apparatus to dispense one or more objects, and, in response to the user submitting a request for one or more objects, communicate the request to the object-dispensing apparatus.

In response to receiving the request from the mobile application, the first instructions of the object-dispensing apparatus are configured to physically dispense the one or more objects.

In specific embodiments of the system, the first instructions of the object-dispensing apparatus are further configured to determine, based on the token, that the user is pre-registered for contactless dispensing of objects from the object-dispensing apparatus. Pre-registration provides for the user to associate the token with the mobile communication device identifier.

In other specific embodiments of the system, the mobile application is further configured to present, on the display, the one or more user interfaces that are configured to allow the user to select (i) a volume of objects for dispensing, and (ii) a resource account for acquiring the volume of objects, and, in response to the user submitting a request for a selected volume of objects using a selected resource account, communicate the request to the object-dispensing apparatus. In response to receiving the request and prior to physically dispensing the selected volume of objects, the first instructions of the object-dispensing apparatus are further configured to verify that the selected resource account currently stores sufficient resources required to acquire the selected volume of objects.

In other specific embodiments of the system the object-dispensing apparatus is further configured to determine current availability for each of a plurality of types of an object dispensed by the object-dispensing apparatus, and the mobile application is further configured to present, on the display, the one or more user interfaces that are configured to allow the user to select an amount of each currently available type of the object.

In further specific embodiments of the system, the object-dispensing apparatus comprises (1) an Automated Teller Machine (ATM) including (i) the short-range wireless reader and (ii) the objects being dispensed by the ATM are currency notes, and (2) a backend processing system in network communication with the ATM. In specific such embodiments of the system, the one or more user interfaces are configured to resemble user interfaces that are conventionally presented on a display of the ATM absent contactless processing.

In further related embodiments of the system, in which the object-dispensing apparatus comprises the ATM and the backend processing, the first instructions of the ATM are configured to activate the short-range wireless communication reader to receive the token from the short-range wireless communication-enabled wireless communication device or a short-range wireless communication-enabled payment card device.

In further related embodiments of the system, in which the object-dispensing apparatus comprises the ATM and the backend processing, the first instructions of the backend processing system are further configured to read the token to determine that the user is registered for contactless use of the ATM and that the mobile communication device is registered to perform contactless transactions. In other related embodiments, the first instructions of the ATM are further configured to receive notification from the backend system that the user is registered for contactless use of the ATM, and, in response to receiving the notification, display a user interface on the ATM that (i) instructs the user to view the display on the mobile communication device for contactless transactions, and (ii) provides a selectable option for canceling contactless processing of current ATM transactions

In further related embodiments of the system, in which the object-dispensing apparatus comprises the ATM and the backend processing, the mobile application is further defined as a financial institution mobile application and is configured to, in response to verifying the user authentication credentials, present, on the display, the one or more user interfaces that are configured to allow the user to (1) select (i) an account from which the currency is to be debited, and (ii) the amount of currency, and (2) submit a request for the ATM to dispense currency notes of the selected amount. In further related embodiments of the system, in which the object-dispensing apparatus comprises the ATM and the backend processing, the mobile application is further configured to submit the request to the backend processing system. In such embodiments of the system, the first instructions of the backend processing system are further configured to verify that the selected account currently contains sufficient currency required to satisfy the selected amount, and, in response to verifying, communicate a signal to the ATM that instructs the ATM to dispense currency notes of the selected amount.

In further related embodiments of the system, in which the object-dispensing apparatus comprises the ATM and the backend processing, the first instructions of the ATM device are further configured to, in response to receiving the token, determine a current availability for each of a plurality of currency note denominations, and communicate, to the backend processing system, the current availability for each of the plurality of currency notes denominations. In such embodiments of the system, the first instructions of the backend processing system provide for configuring the one or more user interfaces presented on the mobile application to include a user interface that allows the user to select currency note denominations.

In further related embodiments of the system, in which the object-dispensing apparatus comprises the ATM and the backend processing, the mobile application is further configured to, in response to verifying the user authentication credentials, present, on the display, the one or more user interfaces that are configured to allow the user to submit a second request for depositing currency notes or bank notes at the ATM, and submit the second request to the backend processing system. In such embodiments of the system, the first instructions of the backend processing system are configured to communicate a signal to the ATM that instructs the ATM to prepare for receipt of currency notes or bank notes.

A computer-implemented method for contactless dispensing of objects from an object-dispensing apparatus, defines second embodiments of the invention. The method includes activating, on the object-dispensing apparatus, a short-range wireless communication reader to receive and read a token communicated from a user device in possession of a user. Further the method includes determining, based on the token, a mobile communication device identifier associated with a mobile communication device utilized by the user, and, using the mobile communication identifier, communicating a push notification to the mobile communication device. The push notification notifies the user of contactless use of the object-dispensing apparatus and provides an activatable link configured to launch a mobile application on the mobile communication device.

In addition the method further includes receiving the push notification at the mobile communication device and presenting the push notification on a display of the mobile communication device and, in response to the user selecting the activatable link in the push notification, launching a mobile application stored on the mobile communication device. Further, the method includes, in response to launching the application, receiving user authentication credentials and, in response to verifying the user authentication credentials, presenting, on the display, one or more user interfaces that are configured to allow the user to submit a request for the object-dispensing apparatus to dispense one or more objects. Moreover, the method includes, in response to the user submitting the request, communicating the request to the object-dispensing apparatus, and, in response to the object-dispensing apparatus receiving the request, physically dispensing one or more objects from the object-dispensing apparatus.

In specific embodiments the method further includes determining, based on the token, that the user is pre-registered for contactless dispensing of objects from the object-dispensing apparatus. Pre-registration provides for the user to associate the token with the mobile communication device identifier.

In still further specific embodiments of the method, presenting the one or more user interfaces further includes presenting, on the display, the one or more user interfaces that are configured to allow the user to select a volume of objects for dispensing and a resource account for acquiring the volume of objects. In such embodiments of the method, communicating further includes, in response to the user submitting the request for the selected volume of objects using the selected resource account, communicating the request to the object-dispensing apparatus. Additionally, in such embodiments the method further includes, in response to receiving the request and prior to physically dispensing the selected volume of objects, verifying that the selected resource account currently stores sufficient resources required to acquire the selected volume of objects.

In still further specific embodiments, the method includes determining current availability for each of a plurality of types of an object dispensed by the object-dispensing apparatus. In such embodiments of the method, presenting the one or more user interfaces further includes presenting, on the display, the one or more user interfaces that are configured to allow the user to select an amount of each currently available type of the object.

A computer program product including a non-transitory computer-readable medium defines third embodiments of the invention. The computer-readable includes a first set of codes configured to cause a computerized object-dispensing apparatus to activate, on the object-dispensing apparatus, a short-range wireless communication reader to receive and read a token communicated from a user device in possession of a user. Further, the computer-readable medium includes a second set of codes for causing the computerized object-dispensing apparatus to, determine, based on the token, a mobile communication device identifier associated with a mobile communication device utilized by the user. Additionally, the computer-readable medium includes a third set of codes for causing the computerized object-dispensing apparatus to, based on the mobile communication device identifier, communicate a push notification to the mobile communication device. The push notification notifies the user of contactless use of the object-dispensing apparatus and provides an activatable link configured to launch a mobile application on the mobile communication device.

In addition, the computer-readable medium includes a fourth set of codes for causing the mobile communication device to receive the push notification at the mobile communication device and presenting the push notification on a display of the mobile communication device and a fifth set of codes for causing the mobile communication device to, in response to the user selecting the activatable link in the push notification, launch a mobile application stored on the mobile communication device. Moreover, the computer-readable medium includes a sixth set of codes for causing the mobile communication device to, in response to launching the mobile application, receive user authentication credentials and a seventh set of codes for causing the mobile communication device to, in response to verifying the user authentication credentials, display, within the mobile application, one or more user interfaces that are configured to allow the user to submit a request for the object-dispensing apparatus to dispense one or more objects. In addition, the computer-readable medium includes an eighth set of codes for causing the mobile communication device to, in response to the user submitting the request, communicate the request to the object-dispensing apparatus, and a ninth set of codes for causing the computerized object-dispensing apparatus to, in response to receiving the request, physically dispensing one or more objects from the object-dispensing apparatus.

In specific embodiments of the computer program product, the second set of codes is further configured to cause the computerized object-dispensing apparatus to determine, based on the token, that the user is pre-registered for contactless dispensing of objects from the object-dispensing apparatus. Pre-registration provides for the user to associate the token with the mobile communication device identifier.

In other specific embodiments of the computer program product, the seventh set of codes is further configured to cause the mobile communication device to display, within the mobile application, the one or more user interfaces that are configured to allow the user to select a volume of objects for dispensing and a resource account for acquiring the volume of objects. In such embodiments of the computer program product, the eighth set of codes is further configured to cause the mobile communication device to, in response to the user submitting the request for the selected volume of objects using the selected resource account, communicate the request to the object-dispensing apparatus. Additionally, in such embodiments of the computer program product, the ninth set of codes is further configured to cause the computerized object-dispensing system to, in response to receiving the request and prior to physically dispensing the selected volume of objects, verify that the selected resource account currently stores sufficient resources required to acquire the selected volume of objects.

Thus, systems, apparatus, methods, and computer program products herein described in detail below provide for contactless dispensing of objects from object-dispensing machines, such as vending machines, ATMs and the like. No initial contact with the machine is made possible by communicating a digital token to the machine via short-range wireless communication, such as Near Field Communication (NFC) or the like. In response, a push notification is communicated to the user's wireless device, which includes an activatable link for launching a mobile application. In response to launching the mobile application and authenticating the user, the mobile application provides object-dispensing machine-like user interfaces that are configured to allow the user to input object requesting parameters and submit a request for the object(s) to be dispensed from the object-dispensing machine. The request is communicated to the object-dispensing machines (or corresponding backend processing systems) and, once the request is verified, the object-dispensing machine dispenses the requested objects.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 is a schematic/block diagram of a system for contactless dispensing of objects from an object-dispensing machine, in accordance with embodiments of the present disclosure;

FIG. 2 is a schematic/block diagram of a system for contactless dispensing of objects from an object-dispensing machine, in accordance with embodiments of the present disclosure;

FIG. 3 is a schematic diagram of system for contactless dispensing of currency notes from an Automated Teller Machine (ATM), in accordance with embodiments of the present invention;

FIG. 4 is flow diagram of a method for contactless dispensing of currency notes from an Automated Teller Machine (ATM), in accordance with embodiments of the present invention;

FIG. 5 is a swim-lane flow diagram of a method for contactless dispensing of currency notes from an Automated Teller Machine (ATM), in accordance with embodiments of the present invention; and

FIG. 6 is a flow diagram of method for contactless dispensing of objects from an object-dispensing machine, in accordance with embodiments of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted, or unscripted programming language such as PYTHON, JAVA, PERL, SMALLTALK, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Thus, as described in more detail below, embodiments of the present invention provide for a seamless system, method and the like for contactless dispensing of objects from object-dispensing devices, such as vending machines, ATMs or the like.

Specifically, the process avoids any initial contacting by the user at the object-dispensing device by transferring a user-identifying digital token to the device via short-range wirelessly communication. For example, in specific embodiments of the invention, a card device or mobile communication device equipped with an Near Field Communication (NFC) chip is “tapped” (i.e., comes within near-field range) at a corresponding NFC reader within or proximate to the object-dispensing device. The information stored within the token allows for the object-dispensing device (or network-accessible backend systems connected to the object-dispensing device) to determine that the user is registered for contactless object dispensing and a mobile communication device identifier that the user has associated with the contactless object dispensing process.

In response, the backend system communicates a push notification to the mobile communication device which notifies the user of the contactless process and requests the user to activate a link in the notification to launch a mobile application on the mobile device. Once the mobile application launches, the user is initially required to provide authentication credentials (e.g., pin number or biometric data). Upon verification of the authentication credentials, the user is provided an object-dispensing machine-like experience through the mobile application. For example, in the ATM scenario in which the user desires to withdraw currency notes, the mobile application presents user interfaces that allow the user to select an account from which the withdrawal will occur and withdrawal amount. Once the user submits the request via the mobile application, the request is communicated to the backend system, which performs one or more verifications procedures (e.g., ensures that the selected account contains sufficient funding) and subsequently communicates a command to the object-dispensing machine instructed the machine to dispense to object(s).

In other embodiments of the invention, the object-dispensing device is further configured for other contactless procedures, such as insertion of objects into the device. For example, in the ATM scenario, in which the user desires to deposit currency notes or bank notes, the mobile application presents user interfaces that allow the user to select the deposit account, the deposit type (i.e., currency notes or bank notes) and deposit amount and, in response, the device is configured to prepare for and receive receipt of the currency or bank notes.

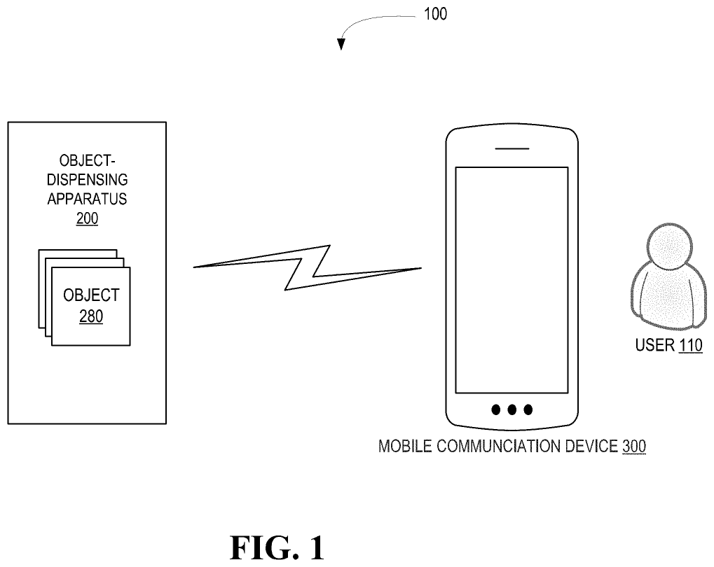

Turning now to the figures, FIG. 1 illustrates a system 100 for contactless dispensing of objects from an object-dispensing apparatus, in accordance with embodiments of the present invention. The system comprises an object-dispensing apparatus 200 which is configured to dispense objects 280 to users. The object-dispensing apparatus 200 may comprise a vending machine, an ATM or any other machine/device that dispenses objects/items required of the users. The object-dispensing apparatus 200 may comprise more than one device, such as an object-dispensing machine and backend processing device(s) (e.g., servers, routers and the like) that are in network communication with the object-dispensing machine. In conventional use, users will interact with the object-dispensing machine, such as physically contacting/touching input devices, including buttons, touch-screens and the like to conduct the object dispensing process.

The system 100 additionally includes a mobile communication device 200, such as a mobile telephone (i.e., smart phone) in possession of a user 110 who desires to receive objects 280 dispensed from object-dispensing apparatus 200. According to embodiments of the invention, the user 110 is able to seamlessly conduct the object-dispensing process entirely on the mobile communication device 300 without having to physically contact any input device on the object-dispensing machine 200. The process by which the user 110 obtains the objects 280 without having to contact the object-dispensing machine is highly intuitive, such that, the user 110 does not have to recall instructions or actions necessary for the process to occur. Moreover, in specific embodiments of the invention, the mobile communication device 200 displays user interfaces that replicate the user interfaces that would otherwise be displayed on the object-dispensing apparatus 200 when conducting the conventional object-dispensing process. As a result, the contactless object-dispensing process of the present invention allows user 110 to obtain the object(s) 280 within the same timeframe as would be expected if the user 110 were to obtain the object(s) 280 using the convention object-dispensing process (i.e., physically contacting the input devices on the object-dispensing apparatus 200).

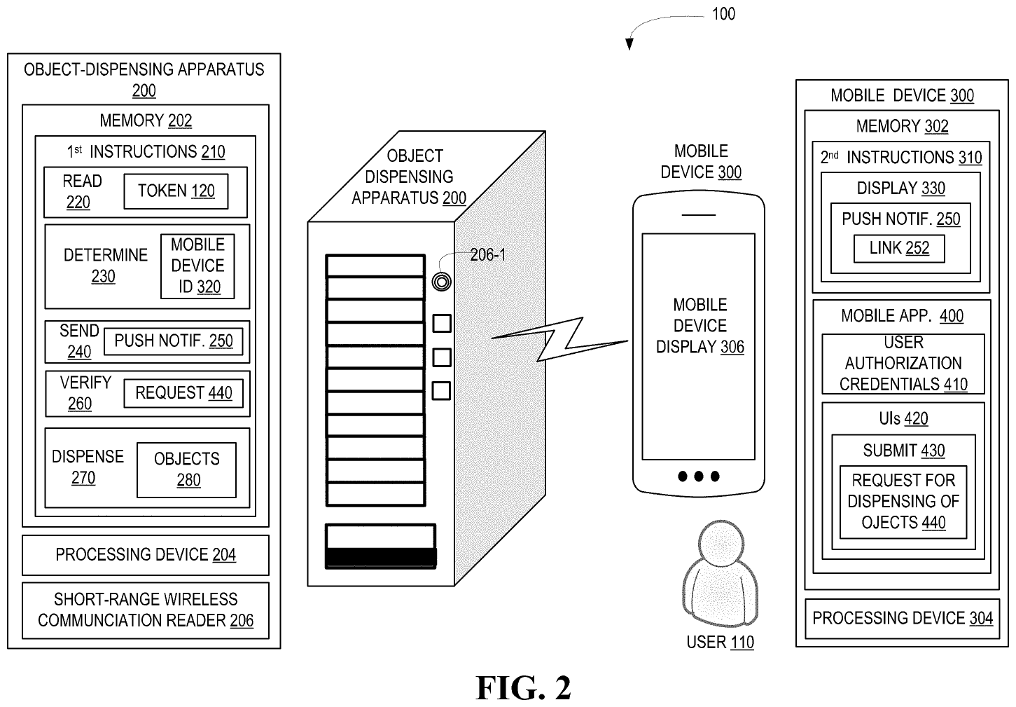

Referring to FIG. 2, a schematic/block diagram is depicted of system 100 for contactless object dispensing from object-dispensing machines, in accordance with embodiments of the present invention. As discussed in relation to FIG. 1, the system includes an object-dispensing apparatus 200, which may comprise one or more devices, and a mobile communication device 300, which is in possession of a user 110 who desires to obtain objects 280 from the object-dispensing apparatus 200 without having to physically contact the object-dispensing apparatus 200.

The object-dispensing apparatus 200 includes a memory 202, one or more processing devices 204 in communication with the memory 202 and a short-range wireless communication reader 206 in communication with the processing device 204. Memory 202 may comprise volatile and non-volatile memory, such as read-only and/or random-access memory (RAM and ROM), EPROM, EEPROM, or any memory common to computing platforms. Moreover, memory 202 and the like may comprise cloud storage, such as provided by a cloud storage service and/or a cloud connection service.

Processing device 204 or the like may be an application-specific integrated circuit (“ASIC”), or other chipset, logic circuit, or other data processing device. Processing device(s) 204 or the like may execute one or more application programming interface (APIs) (not shown in FIG. 2) that interface with any resident programs, such as first instructions 210 or the like stored in the memory 202 of the object-dispensing apparatus 200 and any external programs. Processing device(s) 204 may include various processing subsystems (not shown in FIG. 2) embodied in hardware, firmware, software, and combinations thereof, that enable the functionality of the object-dispensing apparatus 200 and the operability of the object-dispensing apparatus 200 on a communications network (not shown in FIG. 2). For example, processing subsystems allow for initiating and maintaining communications and exchanging data with other networked devices. For the disclosed aspects, processing subsystems of object-dispensing apparatus 200 may include any processing subsystem used in conjunction with first instructions 210 and related engines, tools, routines, sub-routines, algorithms, sub-algorithms, sub-modules thereof.

Additionally, the object-dispensing apparatus 200 includes a short-range wireless communication reader 206, such as a Near Field Communication (NFC) reader or like. The reader 206 may have an identifier 206-1 located on the exterior of the object-dispensing apparatus 200 that notifies the user of the location of the reader 206 within the object-dispensing apparatus 200. Short-range wireless communication facilitates the initial communication between the user 110 and the object-dispensing apparatus 200, such that, a user 110 in possession of a device with short-range wireless communication capabilities is able to communicate information, via digital token, that identifies the user and provides the basis for the object-dispensing apparatus 200 to determine that the user desires to conduct contactless dispensing of objects 280 and identify the mobile communication device 300 on which the user desires to conduct the contactless dispensing process.

Further, object-dispensing apparatus 200 includes a network communication interface (not shown in FIG. 2) that is operatively connected to the processing device(s) 204 and is configured to communicate with one or more other devices (e.g., backend processing system devices) on communication network (not shown in FIG. 2). In this regard, the network communication interface may include an antenna operatively coupled to a transmitter and a receiver (together a “transceiver”). The processing device 204 is configured to provide signals to and receive signals from the transmitter and receiver, respectively. The computing apparatus 40 may utilize a wired network and/or wireless network including satellite or any other wireless network to provide signals and receive signals.

Memory 202 of object-dispensing apparatus 200 includes first instructions 210 that are configured to activate the short-range wireless reader 200 to receive and read 220 a digital token 120 communicated from a short-range wireless device in possession of the user 110 (e.g, the mobile communication device 300 or another device, such as card device or the like). The digital token 120 includes information that identifies the user 110. First instructions 210 are further configured to determine 230, based on information stored in the token 120, a mobile communication device identifier 320 associated with a mobile communication device 300 utilized by the user 110. In specific embodiments of the invention, such a determination will be predicated on determining that the user 110 has pre-registered for contactless object-dispensing and, as part of the pre-registration process, has designated a specific mobile communication device as the device on which the user 110 desires to conduct the contactless process. In response to determining the mobile communication device identifier 320, a push notification 250 is sent 240 to the mobile communication device 300. The push notification 250 notifies the user of the impending contactless process and includes an activatable link configured to launch a mobile application 400 on the mobile application device 300.

The mobile communication device 300 includes a memory 302, one or more processing devices 3204 in communication with the memory 302, and a display 306 in communication with the processing device 304. Memory 302 may comprise volatile and non-volatile memory, such as read-only and/or random-access memory (RAM and ROM), EPROM, EEPROM, or any memory common to computing platforms. Moreover, memory 302 and the like may comprise cloud storage, such as provided by a cloud storage service and/or a cloud connection service. Processing device 304 or the like may be an application-specific integrated circuit (“ASIC”), or other chipset, logic circuit, or other data processing device. Processing device(s) 304 or the like may execute one or more application programming interface (APIs) (not shown in FIG. 2) that interface with any resident programs, such as second instructions 310, mobile application 400 or the like stored in the memory 302 of the mobile communication device 300 and any external programs. Processing device(s) 304 may include various processing subsystems (not shown in FIG. 2) embodied in hardware, firmware, software, and combinations thereof, that enable the functionality of the mobile communication device 300 and the operability of the mobile communication device 300 on a communications network (not shown in FIG. 2). For example, processing subsystems allow for initiating and maintaining communications and exchanging data with other networked devices. For the disclosed aspects, processing subsystems of mobile communication device 300 may include any processing subsystem used in conjunction with second instructions 310, mobile application 400 and related engines, tools, routines, sub-routines, algorithms, sub-algorithms, sub-modules thereof.

Additionally, the mobile communication device 300 includes a display 306 that is in communication with processing device(s) 304 and configured to display push notification 250 and user interfaces 420 of mobile application 400.

Further, the mobile communication device 300 includes a communication interface (not shown in FIG. 2) that is operatively connected to the processing device(s) 304 and is configured to communicate with one or more other devices (e.g., backend processing system devices) on communication network (not shown in FIG. 2). In this regard, the network communication interface may include an antenna operatively coupled to a transmitter and a receiver (together a “transceiver”). The processing device 304 is configured to provide signals to and receive signals from the transmitter and receiver, respectively.

Memory 302 of mobile communication device 300 includes second instructions 310 that are configured to receive push notification 250 and display 320 the push notification on mobile communication device display 306. In response to the user 110 activating the link 252 in the push notification 250, mobile application 400 stored in memory 310 is launched.

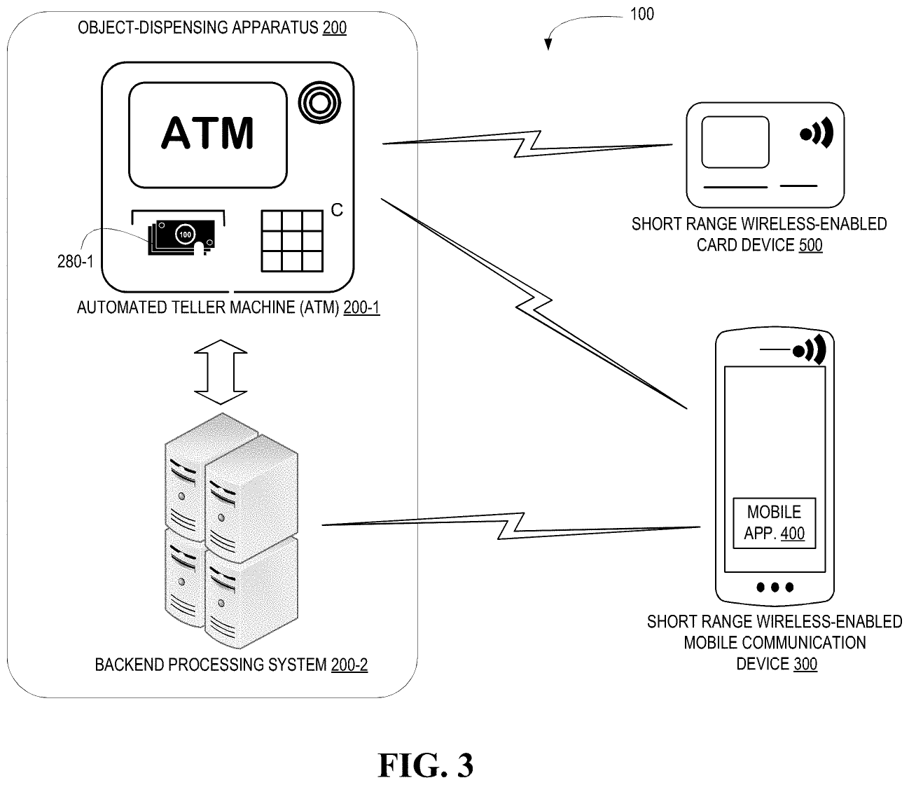

In response to launching mobile application 400, a log-in user interface is displayed that requires the user 110 to input user authentication credentials 410 (e.g., username/passcode, biometrics or the like). The user authentication credentials may be verified at the mobile communication device 300 or may be verified by backend processing system (200-2 shown in FIG. 3). In response to verifying the user authentication credentials of the user 110, the mobile application 400 is configured to display one or more user interfaces 420 that allow the user 110 to submit 430 a request 440 for dispensing of objects 280 from the object-dispensing apparatus. The user interfaces 420 may be configured to allow the user 110 to select an object amount and, where applicable, an account for rendering a payment for the object(s).

In response to the user 110 submitting 430 the request 440, the request 440 is communicated to the object-dispensing apparatus 200. First instructions 210 of the object-dispensing apparatus 200 are further configured to verify 260 the request 440. Verification 260 may, in specific embodiments of the invention, involve verifying that the selected account has sufficient resources/funds to provide for the object(s). Further, in response to verifying 260 the request 440, first instructions 210 are configured to instruct the object-dispensing apparatus 200 to dispense 270 the object(s) 280. Additionally, first instructions 210 may be configured to generate an e-receipt of the object-dispensing process, which can be communicated to the user, via text, email or the like or populated within an e-receipt depository of the mobile application 400.

Referring to FIG. 3, a schematic diagram is presented of a system 100 for contactless dispensing of currency notes 280-1 from an Automated Teller Machine (ATM) 200-1, in accordance with embodiments of the present invention. Thus, in the illustrated embodiment of FIG. 3, the object-dispensing apparatus 200 includes (i) ATM 200-1 configured to dispense objects 280 in the form of currency notes 280-1, and (ii) a backend processing system 200-2 that is in network communication with the ATM 200-1.

Either a short-range wireless-enabled mobile communication device 300 or a short-range wireless-enable card device 500 (e.g., payment card) communicates the digital token 120 (shown in FIG. 2) to the ATM 200-1. In turn, the information in the token is communicated to the backend processing system 200-2 to determine the mobile communication device identifier 320 and, in specific embodiments of the invention, that the user has pre-registered for contactless dispensing of currency notes 280-1 at the ATM 200-1. The backend-processing system 200-2 subsequently communicates the push notification 250 (shown in FIG. 2) to the mobile communication device 300. Subsequently, when the user submits a request for hard currency via the mobile application 400, the request is communicated to the backend processing system 200-2, which upon verification of the request, sends instructions to the ATM 200-1 to dispense the hard currency.

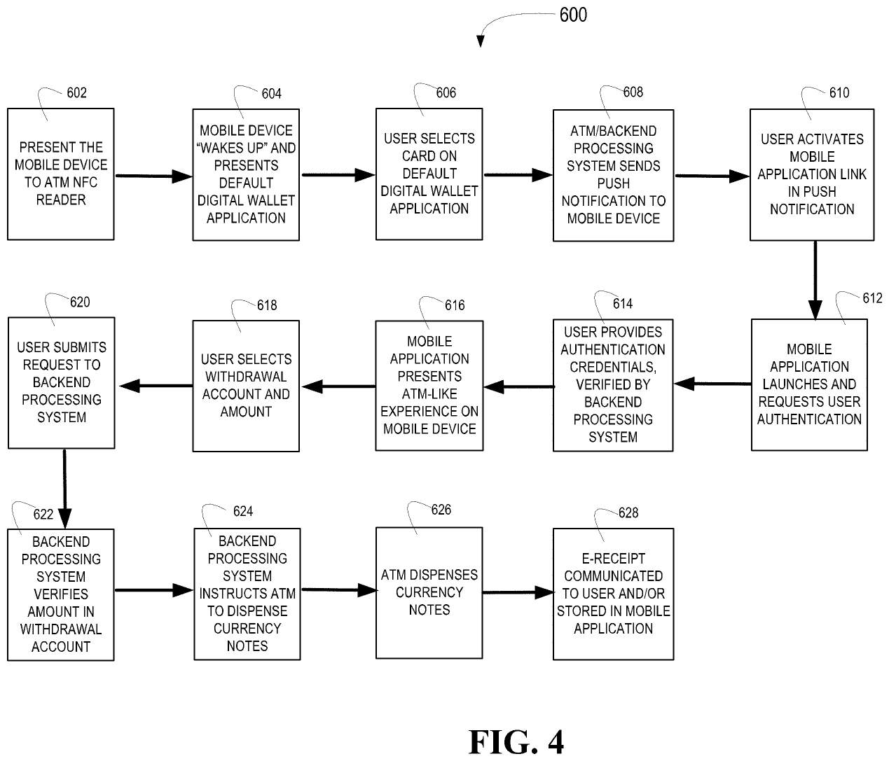

Referring to FIG. 4 a flow diagram is presented of a method 600 for contactlessly dispensing currency notes at an ATM, in accordance with embodiments of the present invention. At Event 602, a user presents their mobile communication device to an ATM's NFC reader. In response, the mobile communication device “wakes up” and, at Event 604, presents the user's default digital wallet application (i.e., the only digital wallet on the device or the wallet that the user has associated with the mobile device's digital token). At Event 606, the user selects a card from the digital wallet.

In specific embodiments of the invention, the card selected by the user will be card that the user has pre-registered for contactless dispensing of currency notes (i.e., cash). In addition, the pre-registration process involves associating a mobile communication identifier with the card/user account. Pre-registration may occur online or within a mobile application. In other embodiments of the invention, the user may pre-register during an ATM session, such, that subsequent ATM sessions are subject to contactless currency note dispensing. In other embodiments of the invention, the user may register during an ATM session such that the pending hard currency withdrawal is configured by the user at the mobile device as opposed to the ATM (i.e., a push notification is sent to the user's mobile communication device in response to the user registering at the ATM and, all subsequent inputs are provided to the mobile communication device as opposed to the ATM).

In response to determining the user's mobile communication device identifier. At Event 608, the backend processing system sends a push notification to the mobile communication device associated with the mobile communication device identifier. In response to the mobile communication device displaying the push notification, at Event 610, the user activates the mobile application link in the push notification and, at Event 612, the mobile application (e.g., associated financial institution mobile application) is launched and requests that the user provide user authentication credentials (i.e., username/passcode, biometrics or the like). In response to the user inputting requisite user authentication credentials, at Event 614, the credentials are communicated to the backend system for verification/authentication purposes.

In response to verifying/authenticating the user, at Event 616, the mobile application presents an ATM-like experience on the mobile device. The ATM-like experience may include replicas of user interfaces presented at the ATM when conducting conventional currency note withdrawals or other processes. The ATM-like experience may include other user interfaces that are configured to allow for the user to perform other contactless processes, such as, but not limited to depositing currency notes or bank notes via the ATM. At Event 618, the selects currency note withdrawal parameters, including the account from which funds are being withdrawn and the amount of the withdrawal. In response to selecting the parameters, at Event 620, the user submits the request and the request is communicated to the backend processing system.

In response to receiving the request, at Event 622, the backend processing system verifies the request, i.e., that the selected account has sufficient resources/funds for withdrawing the selected amount , and, in response to verifying the request, at Event 624, sends a command to the ATM instructing the ATM to dispense currency notes in the selected amount. At Event 626, the ATM dispenses currency notes in the selected amount and, At Event 628, an e-receipt is generated and communicated to the user via email, text or the like and/or stored in a repository accessible via the mobile application.

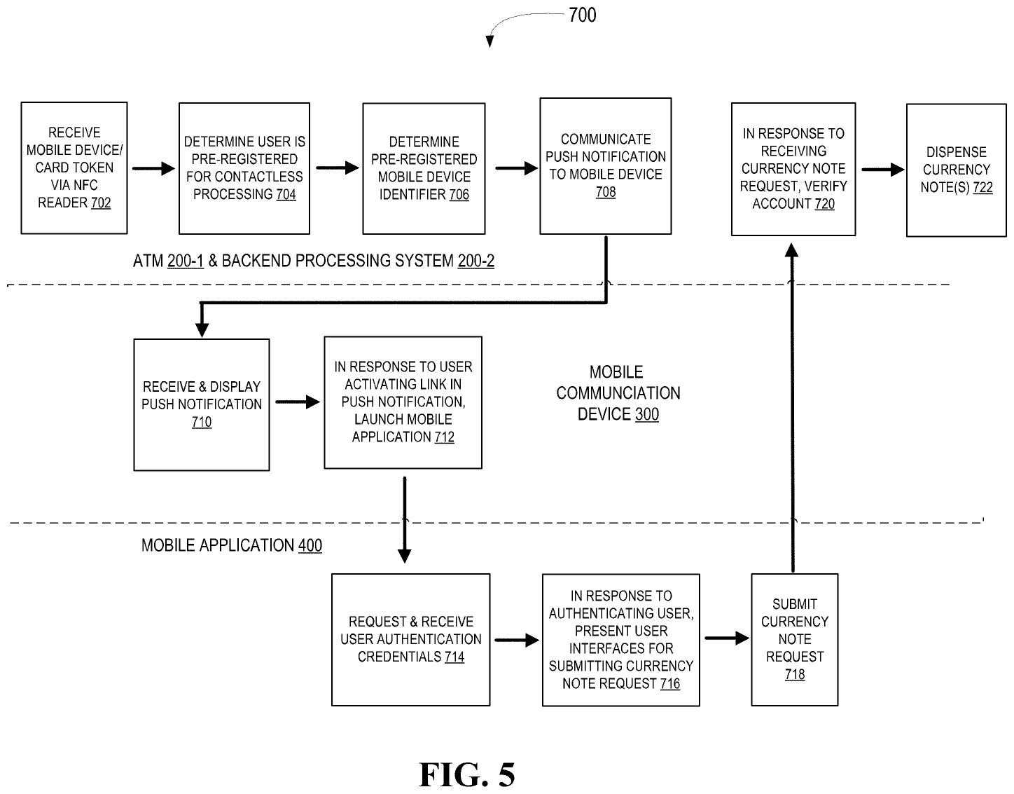

Referring to FIG. 5, a swim-lane flow diagram is depicted of a method 700 contactless dispensing of currency notes from an ATM, in accordance with embodiments of the present invention. At Event 702, a digital token is communicated from a mobile communication device or a card device to an ATM using short-range wireless communication, such as NFC. The digital token stores account information which identifies the user. At Event 704, based on information in the token, a determination is made, by the backend-processing system, that the user has pre-registered for contactless ATM interaction (e.g., contactless withdrawal of currency notes or depositing of currency noted and/or bank notes). At Event 706, based on the pre-registration, a determination is made, by the backend processing system, as to a pre-registered mobile communication device identifier (i.e., the mobile communication device the user has designated for the contactless ATM interactions). At Event 708, the backend processing system communicates a push notification to the mobile communication device notifying the user of impending contactless ATM interactions and including a link for launching the mobile application associated with the user's financial institution. It should be noted that, in specific embodiments of the invention, in conjunction with communicating the push notification, the backend processing system may signal the ATM to display a screen that (i) requests the user to view the display on their mobile communication display, and (ii) provides an option for the user to opt-out of the contactless interaction process and perform the interactions conventionally using the input mechanisms on the ATM.

At Event 710, the mobile communication device receives and displays the push notification and, at Event 712, in response to the user activating the link in the push notification, launches the mobile application.

In response to launching the mobile application, at Event 714, a user interface requests that the user input user authentication credentials (e.g., username/passcode, biometrics or the like) and the user authentication credentials are received/inputted. In response to communicating the credentials to the backend processing system, which, in turn, verifies the authentication of the user, at Event 716, user interfaces are presented within the mobile application that are configured to allow the user to submit a currency note withdrawal request. In specific embodiments of the invention, the user interfaces replicate or closely resemble the user interfaces that are presented on the ATM during a conventional ATM interaction. In such embodiments, the user is familiar with the user interfaces, such that, the process can be efficiently conducted without user delay. Subsequent to presenting user interfaces that allow the user to configure the withdrawal, a user interface that allows the user to select a preferred language for configuring the currency note withdrawal may be presented to the user. Further, as mentioned, the user interfaces provide for the user to configure the currency note withdrawal, such as, one or more user interfaces that allow for the user to choose an account from which resources/funds are to be debited from and an amount for withdrawal.

In other embodiments of the invention, the user interfaces may provide for the user select currency denominations for the requested currency note withdrawal. In such embodiments of the invention, the ATM is configured to determine current availability of currency denominations, send a notification to the backend processing system that includes the current availability of currency denominations and, in response, the backend processing system, configures the user interfaces such that the user is only able to select from currency denominations currently available at the ATM.

Additionally, as previously discussed, the user interfaces may provide for the user to select between various ATM interactions, such as, but limited to, currency note withdrawal, currency note depositing and/or bank note (i.e., check) depositing. In specific embodiments of the invention, the user must meet a threshold number of bank note deposits in order to proceed with the contactless process for bank note depositing.

In response to the user configuring the withdrawal (or configuring another ATM interaction), at Event 718, the user submits the request, which is communicated to the back-end processing systems. In response to receiving the request, at Event 720, the backend processing system verifies that that the selected account currently has resources/funds necessary to fund the selected withdrawal amount. In response to verifying the sufficiency of the selected account, at Event 722, instructions are communicated to the ATM to dispense currency notes in the selected amount. In the event that the request includes another ATM interaction, such currency or bank note depositing, the ATM is instructed to preparing for such interaction (e.g., activate currency/bank note insertion mechanisms or the like).

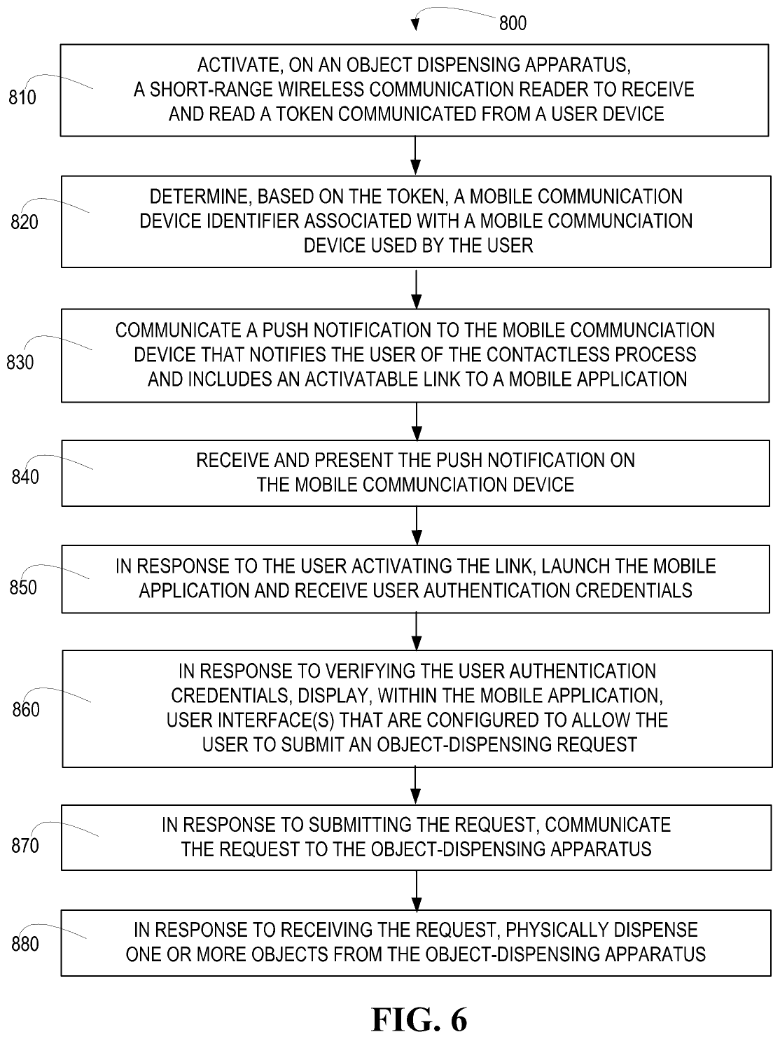

Referring to FIG. 6, a flow diagram is depicted of a method 800 for contactless dispensing of objects from object-dispensing apparatus, in accordance with embodiments of the present invention. At Event 810, a short-range wireless communication reader, such as an NFC reader or the like is activated on an object-dispensing apparatus to receive and read a digital token communicated from a user device (e.g., a wireless communication device, a card device or the like). At Event 810, a mobile communication device identifier is identified based on information stored in the token. The mobile communication identifier is associated with a mobile communication device used by the user. In specific embodiments of the method, determining the mobile communication device identifier is predicated on determining that the user has pre-registered for contactless object-dispensing device interaction, such that the mobile communication identifier is associated with the pre-registration process. In other specific embodiments of the method, the object-dispensing apparatus may determine current availability of certain types of objects (e.g., current availability of specific denominations of currency notes), which is subsequently used in presenting object dispensing options to the user.

At Event 830, a push notification is communicated to the mobile communication device that is configured to notify the user of the contactless process and includes an activable link to a mobile application. In additional embodiments of the method, the display of the object-dispensing apparatus is configured to display (i) a message requesting the user to view the display on their mobile communication device, and (ii) an option to opt-out of the contactless process and perform the object-dispensing process on the option-dispensing apparatus.

At Event 840, the push notification is received by and displayed on the mobile communication device and in response to the user activating the link in the push notification, at Event 850, a mobile application is launched and the mobile application requests user authentication credentials. In response to the user inputting the authentication credentials and the object-dispensing apparatus verifying the credentials, at Event 860, the mobile application displays user interfaces that are configured to allow the user to submit an object dispensing request. In addition, the user interfaces may, in specific embodiments, provide for the user to input object dispensing parameters, such as, but not limited to, an account for funding the object acquisition, an amount of objects requested, types of objects requested (e.g., denomination of currency notes and the like) and the like.

In alternate embodiments of the method, the user interfaces may provide for the user to select between more than one apparatus interaction, such as, but not limited to, object dispensing, object insertion and the like. In such embodiments of the invention, once the user provides an interaction type selection, the mobile application is configured to present user interactions that allow the user to configure the selected interaction (e.g., select the type objects being inserted and/or the quantity of objects being inserted).

In response to submitting the request, at Event 870, the request is communicated to the object-dispensing apparatus, which, in specific embodiments of the method, verifies the request. In response to receiving the request an, in some instances, verifying the request, at Event 880, the object-dispensing apparatus physically dispenses the selected one or more objects.

As evident from the preceding description, the systems, methods and the like described herein represents an improvement in technology, specifically, embodiments of the present invention provide an efficient and intuitive means for contactless dispensing of objects from object-dispensing devices. By eliminating any physical contact/interaction with the object dispensing device the user eliminates the possibility of acquiring germs from the input mechanisms of the device. The invention relies on the user communicating a digital token to the object-dispensing apparatus that identifies the user and serves as the basis for determining a mobile device identifier associated with the user. In turn, a push notification is communicated to the user's mobile device that includes a link for launching a mobile application. At the onset of launching the mobile application, user authentication credentials are requested, received and verified, and, in response user interfaces are presented within the mobile application that provide an object-dispensing apparatus-like experience—allowing the user to configure and submit the object request to the object-dispensing apparatus, which subsequently physically dispenses the requested objects.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for contactless dispensing of objects from an object-dispensing apparatus, the system comprising:
an object-dispensing apparatus comprising a first memory, at least one first processing device in communication with the first memory, a short-range wireless communication reader in communication with the first processing device, and first instructions stored in the first memory, executable by the first processing devices and configured to:
activate the short-range wireless communication reader to receive and read a token associated with a user,
determine, based on the token, a mobile communication device identifier associated with a mobile communication device utilized by the user,
communicate a push notification to the mobile communication device based on the mobile communication device identifier, wherein the push notification notifies the user of contactless use of the object-dispensing apparatus and provides an activatable link configured to launch a mobile application on the mobile communication device;
the mobile communication device comprising a second memory, a second processing device in communication with the second memory, a display in communication with the second processing device, and second instructions stored in the second memory, executable by the second processing device and configured to receive the push notification and present the push notification on the display; and
the mobile application stored in the second memory, executable by the second processor and configured to:
launch in response to the user selecting the activatable link in the push notification,
in response to launch, request and receive user authentication credentials,
in response to verifying the user authentication credentials, present, on the display, one or more user interfaces that are configured to allow the user to submit a request for the object-dispensing apparatus to dispense one or more objects,
in response to the user submitting a request for one or more objects, communicate the request to the object-dispensing apparatus,
wherein in response to receiving the request, the first instructions of the object-dispensing apparatus are configured to physically dispense the one or more objects.

2. The system of claim 1, wherein the first instructions of the object-dispensing apparatus are further configured to:
determine, based on the token, that the user is pre-registered for contactless dispensing of objects from the object-dispensing apparatus, wherein pre-registration provides for the user to associate the token with the mobile communication device identifier.

3. The system of claim 1, wherein the mobile application is further configured to:
present, on the display, the one or more user interfaces that are configured to allow the user to select a volume of objects for dispensing and a resource account for acquiring the volume of objects, and
in response to the user submitting a request for a selected volume of objects using a selected resource account, communicate the request to the object-dispensing apparatus,
wherein in response to receiving the request and prior to physically dispensing the selected volume of objects, the first instructions of the object-dispensing apparatus are configured to verify that the selected resource account currently stores sufficient resources required to acquire the selected volume of objects.

4. The system of claim 1, wherein the first instructions of the object-dispensing apparatus are further configured to determine current availability for each of a plurality of types of an object dispensed by the object-dispensing apparatus, and
wherein the mobile application is further configured to present, on the display, the one or more user interfaces that are configured to allow the user to select an amount of each currently available type of the object.

5. The system of claim 1, wherein the object-dispensing apparatus comprises:
an Automated Teller Machine (ATM) including the short-range wireless reader and the objects being dispensed by the ATM are currency notes; and
a backend processing system in network communication with the ATM.

6. The system of claim 5, wherein the first instructions of the ATM are configured to:
activate the short-range wireless communication reader to receive the token from the wireless communication device or a payment card device, wherein the wireless communication and the payment card device are short-range wireless communication-enabled,
communicate the token to the backend processing system.

7. The system of claim 5, wherein the first instructions of the backend processing system are configured to:
read the token to determine that the user is registered for contactless use of the ATM and that the mobile communication device is registered to perform contactless transactions.

8. The system of claim 7, wherein the first instructions of the ATM are further configured to:
receive notification from the backend system that the user is registered for contactless use of the ATM, and
in response to receiving the notification, display a user interface that (i) instructs the user to view the display on mobile communication device for contactless transactions, and (ii) provides a selectable option for canceling contactless processing of current ATM transactions.

9. The system of claim 5, wherein the mobile application is further defined as a financial institution mobile application and is configured to:
in response to verifying the user authentication credentials, present, on the display, the one or more user interfaces that are configured to allow the user to (1) select (i) an account from which the currency is to be debited, and (ii) the amount of currency and (2) submit a request for the ATM to dispense currency notes of the selected amount.

10. The system of claim 9, wherein the mobile application is further configured to:
submit the request to the backend processing system,
wherein the first instructions of the backend processing system are further configured to:
verify that the selected account currently contains currency required to satisfy the selected amount, and
in response to verifying that the selected account currently contains currency required to satisfy the selected amount, communicate a signal to the ATM that instructs the ATM to dispense currency notes of the selected amount.

11. The system of claim 5, wherein the one or more user interfaces are configured to substantially replicate user interfaces that are conventionally presented on a display of the ATM absent contactless processing.

12. The system of claim 5, wherein the first instructions of the ATM device are further configured to:
in response to receiving the token, determine a current availability for each of a plurality of currency note denominations, and
communicate, to the backend processing system, the current availability for each of the plurality of currency notes denominations,
wherein the first instructions of the backend processing system provide for configuring the one or more user interfaces presented on the mobile application to include a user interface that allows the user to select currency note denominations.

13. The system of claim 5, wherein the mobile application is further configured to:
in response to verifying the user authentication credentials, present, on the display, the one or more user interfaces that are configured to allow the user to submit a second request for depositing currency notes or bank notes at the ATM, and
submit the second request to the backend processing system,
wherein the backend processing system is configured to communicate a signal to the ATM that instructs the ATM to prepare for receipt of currency notes or bank notes.

14. A computer-implemented method for contactless dispensing of objects from an object-dispensing apparatus, the method comprising:
activating, on the object-dispensing apparatus, a short-range wireless communication reader to receive and read a token communicated from a user device in possession of a user;
determining, based on the token, a mobile communication device identifier associated with a mobile communication device utilized by the user;
using the mobile communication identifier, communicating a push notification to the mobile communication device, wherein the push notification notifies the user of contactless use of the object-dispensing apparatus and provides an activatable link configured to launch a mobile application on the mobile communication device;
receiving the push notification at the mobile communication device and presenting the push notification on a display of the mobile communication device;
in response to the user selecting the activatable link in the push notification, launching a mobile application stored on the mobile communication device;
in response to launching the application, receiving user authentication credentials;
in response to verifying the user authentication credentials, presenting, on the display, one or more user interfaces that are configured to allow the user to submit a request for the object-dispensing apparatus to dispense one or more objects;
in response to the user submitting the request, communicating the request to the object-dispensing apparatus; and
in response to the object-dispensing apparatus receiving the request, physically dispensing one or more objects from the object-dispensing apparatus.

15. The computer-implemented method of claim 14, further comprising:
determining, based on the token, that the user is pre-registered for contactless dispensing of objects from the object-dispensing apparatus, wherein pre-registration provides for the user to associate the token with the mobile communication device identifier.

16. The computer-implemented method of claim 14, wherein presenting the one or more user interfaces further comprises presenting, on the display, the one or more user interfaces that are configured to allow the user to select a volume of objects for dispensing and a resource account for acquiring the volume of objects, and
wherein communicating further comprises, in response to the user submitting the request for the selected volume of objects using the selected resource account, communicating the request to the object-dispensing apparatus, and
wherein the computer-implemented method further comprises, in response to receiving the request and prior to physically dispensing the selected volume of objects, verifying that the selected resource account currently stores sufficient resources required to acquire the selected volume of objects.

17. The computer-implemented method of claim 14, further comprising:
determining current availability for each of a plurality of types of an object dispensed by the object-dispensing apparatus, and
wherein presenting the one or more user interfaces further comprises presenting, on the display, the one or more user interfaces that are configured to allow the user to select an amount of each currently available type of the object.

18. A computer program product including non-transitory computer-readable medium that comprises:
a first set of codes configured to cause a computerized object-dispensing apparatus to activate, on the object-dispensing apparatus, a short-range wireless communication reader to receive and read a token communicated from a user device in possession of a user;
a second set of codes for causing the computerized object-dispensing apparatus to, determine, based on the token, a mobile communication device identifier associated with a mobile communication device utilized by the user;
a third set of codes for causing the computerized object-dispensing apparatus to, based on the mobile communication device identifier, communicate a push notification to the mobile communication device, wherein the push notification notifies the user of contactless use of the object-dispensing apparatus and provides an activatable link configured to launch a mobile application on the mobile communication device;
a fourth set of codes for causing the mobile communication device to receive the push notification at the mobile communication device and presenting the push notification on a display of the mobile communication device;
a fifth set of codes for causing the mobile communication device to, in response to the user selecting the activatable link in the push notification, launch a mobile application stored on the mobile communication device;
a sixth set of codes for causing the mobile communication device to, in response to launching the mobile application, receive user authentication credentials;
a seventh set of codes for causing the mobile communication device to, in response to verifying the user authentication credentials, display, within the mobile application, one or more user interfaces that are configured to allow the user to submit a request for the object-dispensing apparatus to dispense one or more objects;
an eighth set of codes for causing the mobile communication device to, in response to the user submitting the request, communicate the request to the object-dispensing apparatus; and
a ninth set of codes for causing the computerized object-dispensing apparatus to, in response to receiving the request, physically dispensing one or more objects from the object-dispensing apparatus.

19. The computer program product of claim 18, wherein the second set of codes is further configured to cause the computerized object-dispensing apparatus to determine, based on the token, that the user is pre-registered for contactless dispensing of objects from the object-dispensing apparatus, wherein pre-registration provides for the user to associate the token with the mobile communication device identifier.

20. The computer program product of claim 18,
wherein the seventh set of codes is further configured to cause the mobile communication device to display, within the mobile application, the one or more user interfaces that are configured to allow the user to select a volume of objects for dispensing and a resource account for acquiring the volume of objects, and
wherein the eighth set of codes is further configured to cause the mobile communication device to, in response to the user submitting the request for the selected volume of objects using the selected resource account, communicate the request to the object-dispensing apparatus, and
wherein the ninth set of codes is further configured to cause the computerized object-dispensing system to, in response to receiving the request and prior to physically dispensing the selected volume of objects, verify that the selected resource account currently stores sufficient resources required to acquire the selected volume of objects.
